(19) United States
(12) Patent Application Publication
(10) Pub. No.: US 2022/0143783 A1
(43) Pub. Date: May 12, 2022

(54) Method of Etching Glass

(71) Applicant: Millerworks, Inc. d/b/a Pavo Real Glass, Greenville, TX (US)

(72) Inventors: Joe F. Miller, Greenville, TX (US); Hunter Miller, Greenville, TX (US); Cody Miller, Greenville, TX (US); Barbara Miller, Greenville, TX (US)

(73) Assignee: Millerworks, Inc. d/b/a Pavo Real Glass, Greenville, TX (US)

(21) Appl. No.: 17/429,990

(22) PCT Filed: Feb. 13, 2020
(86) PCT No.: PCT/US2020/018131

§ 371 Date: Aug. 11, 2021

Related U.S. Application Data
(60) Provisional application No. 62/805,222, filed on Feb. 13, 2019.

(51) Int. Cl. B24C 1/04; B41M 1/12; B41M 1/34

(52) U.S. Cl. CPC B24C 1/04; B41M 1/34; B41M 1/12

(57) ABSTRACT

A process for etching glass includes: loading a piece of glass on a flatbed digital printer; applying a selected pre-coat solution to the glass to prevent the ink from permanently adhering to the glass; printing a mask having a selected pattern on the glass with the digital printer; sandblasting the masked glass; stripping away the mask from the glass to reveal the etched glass; and cleaning any residual mask and/or pre-coat solution from the glass.

### TECHNICAL FIELD

The technical field is etching glass.

### DESCRIPTION OF PRIOR ART

People have been etching glass for many years. There are many uses for etched glass. Some etched glass is solely decorative and other etched glass provides functional advantages, as well. One example of a functional advantage of etched glass is the use of large glass panels in building construction. Etched glass is used in commercial buildings to provide a decorative aspect, but more importantly, to provide a means for deterring birds from flying into the glass.

There are a variety of methods for etching glass, some involving chemical processes, such as etching with acids or other corrosive chemicals; and others involving mechanical processes, such as scraping and sandblasting.

The sandblasting method typically involves several steps, such as: (1) preparing a thin sheet of vinyl with the pattern to be etched, such as by die cutting or otherwise scoring the vinyl; (2) weeding the design from the vinyl; (3) applying transfer tape to the vinyl; (4) applying the weeded vinyl sheet to the piece of glass to be etched; (5) sandblasting the glass to etch the design into the glass; and (6) removing the vinyl sheet from the glass to reveal the final etched piece of glass. This is a very labor-intensive and time-consuming process, involving multiple machines and multiple passes over the glass. If the vinyl is not properly aligned on the glass, it must be reset.

Although great strides have been made in the field of etching glass, may shortcomings remain.

### BRIEF DESCRIPTION OF THE DRAWINGS

FIG. 1 is a perspective view depicting the step of applying a pre-coat to a piece of glass according to the present application, prior to printing on the glass with a digital printer.

FIG. 2 is perspective view depicting the printed glass loaded onto a sandblasting machine prior to subjecting the glass to the sandblasting step according to the present application.

FIG. 3 is a perspective view depicting the step of removing the ink from the sandblasted glass to reveal the etched glass according to the present application.

FIG. 4 is a perspective view depicting the finished etched glass according to the present application.

FIG. 5 is a flow diagram depicting the etching process or a process for obtaining etched glass.

### DESCRIPTION OF THE PREFERRED EMBODIMENT

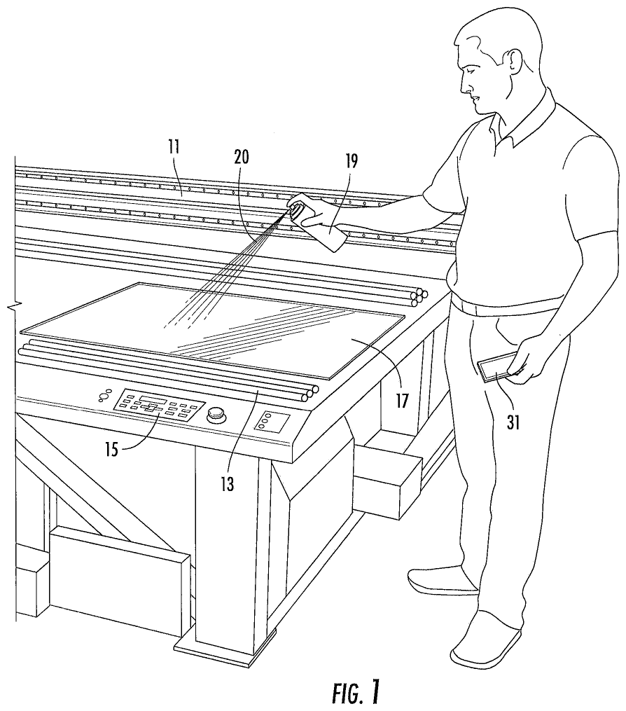

FIG. 1 shows a mask applicator 11, such as a flatbed digital printer, a screen printer, or a vinyl applicator. The mask applicator 11 comprises a lateral mover 13 and a controller 15. The lateral mover 13 is configured for moving laterally-oriented substrates 17 to receive a mask. The lateral mover 13 comprises an automatic feed mechanism, a conveyor, a motor, rollers, pads, gears, or other means for moving a substrate 17 below and/or between sprayers, printer heads, or fusers of the mask applicator 11. A solution applicator 19 applies a treatment, pre-treatment, or pre-coat solution 20 prior to the mask applicator 11 receiving the substrate 17. It is noted that although a lateral orientation is preferred for the mask applicator 11, for example to prevent applied ink from running, other orientations, such as a vertically oriented applicator are encompassed by the present application.

Preferably, the mask applicator 11 is a flatbed digital printer. The flatbed digital printer is the type of printer used to print on small or large planar substrates. The ink may be conventional digital printer ink, or may be a customized ink, depending upon the application. The performance, characteristics, and specifications of the ink may be selectively chosen depending upon the desired application and/or the desired result. For example, in some applications it may be desirable to use inks of different colors, densities, resistance to sandblasting, durability, permanentness, and/or temperature responsiveness, etc. Although the ink may be any conventional ink used in conventional digital printers, it will be appreciated that any ink that would be resistant to sandblasting, but would be easily removable, would be preferred, as such ink would not require the application of a pre-coat solution 20. In a preferred embodiment, the digital printer uses a UV-cured and/or LED-cured ink.

The controller 15 comprises a user interface, including a processor, buttons, control knobs, a touch-screen, a microphone, memory with one or more sets of programmable instructions, and combinations thereof. It will be appreciated that customized and specialized software and/or programming may be designed to control the operation of the digital printer. Such software and/or programming may be stored on and/or run from a computer, tablet, smartphone, and/or network, and may be accessed via wired connections and/or wireless connections and networks. Of course, such software may allow multiple printers to be controlled simultaneously from one or more local and/or remote locations.

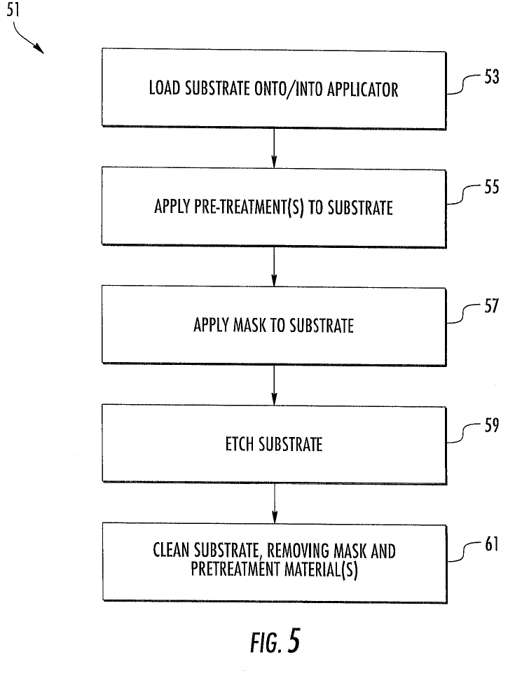

The substrate 17 may be any type or shape of glass, including plexiglass, float glass, laminated glass, and tempered glass, but is preferably a planar sheet of float glass. The process 51 (FIG. 5 below) of the present application is particularly well suited for etching large pieces of glass, such as the type of glass that is used in commercial buildings. In such applications, large numbers of glass panels are required having the same or similar etched patterns. The processes of the present application, including process 51 and its variants, allow these large jobs to be performed quickly, easily, and reliably, thus saving time, money, and material.

The solution applicator 19 comprises a sprayer, a nozzle, a roller, a brush, a compressed gas chamber, an actuator, and combinations thereof. Preferably, the solution applicator 19 is a pneumatically operated spray applicator with a controllable or adjustable nozzle.

The pretreatment solution 20 is a customized pre-coat solution. Depending upon the type of ink used, the pre-coat solution may or may not be necessary; however, in the preferred embodiment, the pre-coat solution 20 is applied to the substrate 17, to ensure that the printed ink can be quickly and easily removed from the substrate after the substrate is sandblasted. The pretreatment 20, or pre-coat solution, may be any of a wide variety of solutions, provided it does not have an adverse effect on the substrate 17 or the material used for the mask, such as ink.

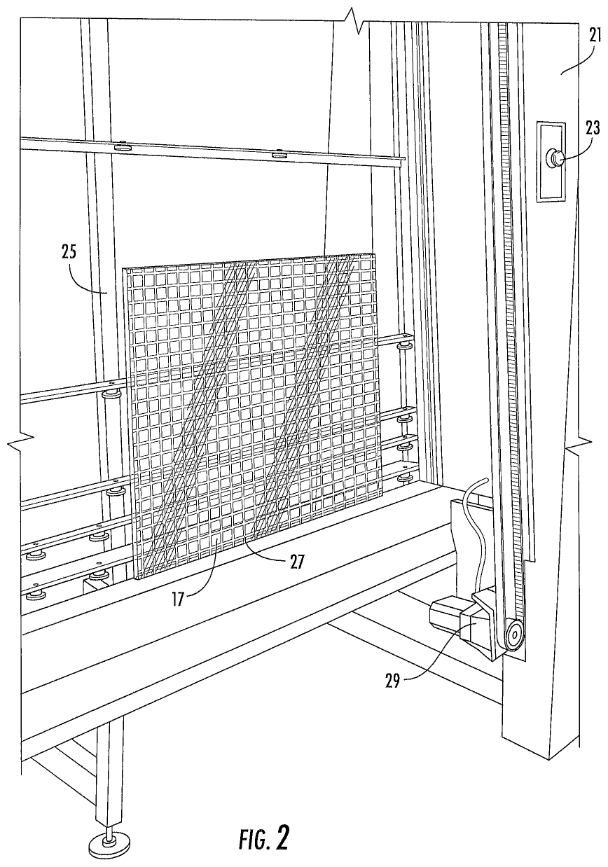

FIG. 2 shows an etch applicator 21, such as a sandblaster, bristle blaster, or other mechanical or chemical etcher. The etch applicator 21 comprises an actuator 23, such as a mechanical lever, an electrical switch, a touch-screen, or other actuation input device. The etch applicator 21 further comprises a substrate support 25 for supporting a substrate 17 that has a mask 27 applied to one or more of its surfaces. The etch applicator 21 further comprises a vertical mover 29. The vertical mover 29 is configured for moving one or more vertically-oriented substrates 17 in order to etch the exposed portions of the substrate(s) 17. It is noted that although a vertical orientation is preferred for the mover 29, enabling sand from the sandblaster to fall to a container below, other orientations, such as a laterally oriented movers are encompassed by the present application.

It is noted that in at least one embodiment, the actuator 23 of the etch applicator 21 and/or the controller 15 of the mask applicator 11 is configured for remote communication. For example, a mobile device 31, such as a smart phone, tablet, PC, laptop, server, or a combination thereof, is communicatively coupled with the controller 15 or the actuator 23 to remotely activate and start either the masking or the etching. The mobile device 31 may also be configured as a main or primary controller for controlling each of the controller 15 of the mask applicator 11 and the actuator 23 of the etch applicator 21, or any of the processes and/or sub-processes discussed in the present application.

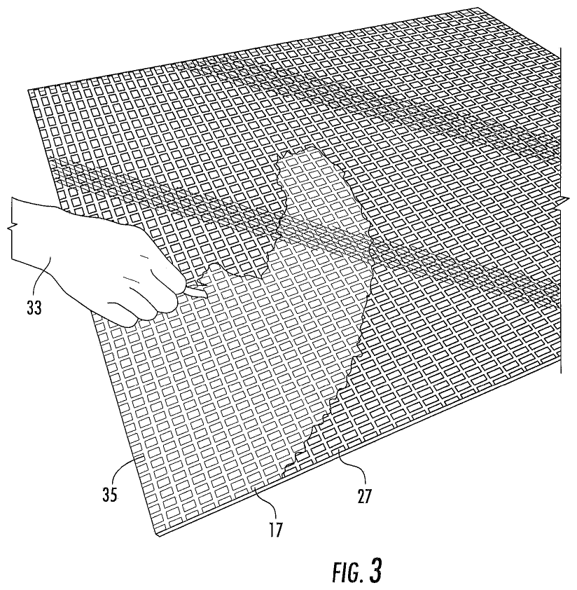

FIG. 3 shows a separator 33 for separating, removing, or stripping the mask 27 from the substrate 17. The separator 33 comprises a chemical, mechanical, abrasive, or pneumatic separator, such as a human hand, automatic continuously operating rollers, cutters, brushes, scrapers, blowers, or combinations thereof. Once the mask 27 is removed from the substrate 17, the etched portion 35 and/or desired pattern of the substrate is revealed.

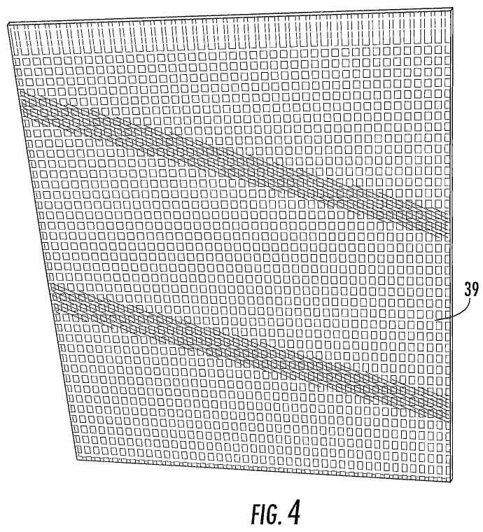

FIG. 4 shows an etched substrate mover 37, comprising a human, a mechanical arm, a forklift, a conveyor belt, a lift, and/or combinations thereof. The etched substrate mover 37 is disposed along the etching assembly line to move the etched substrate 39 to a transporter 41, such as a truck, a ship, or a railcar.

FIG. 5 shows the preferred process 51 for etching substrate 17 to obtain the resulting etched substrate 39, including steps 53 through 61. Step 53 includes loading the substrate 17 into/onto the mask applicator 11, such as loading a piece of glass on a flatbed digital printer. The substrate 17 receives a pre-coat solution 20, which is sprayed onto the substrate 17. In the preferred embodiment, the entire surface of the substrate 17 receives the pre-coat solution 20; however, it will be appreciated that in some applications, only selected portions of the substrate 17 are pre-treated or pre-coated. For example, only portions of the substrate 17 designed to receive the mask 27 may receive the pre-coat solution 20. Also, the pre-coat solution 20 may be deposited, spread, or applied in the form of a thin sheet or layer prior to applying the mask 27.

Step 55 includes applying one or more treatments, pre-treatments, or pre-coat solutions 20 to the substrate 17, such as applying a selected solution to the glass to prevent the ink from permanently adhering to the glass. At step 55, the pre-coat solution 20 may be wiped onto the glass manually, or may be applied by an automated process, such as a continuous spray as the glass is advanced through the printer. In the preferred embodiment, the pre-coat solution 20 is applied in a liquid form; however, it will be appreciated that the pre-coat may be applied in other forms, such as sheets, powders, etc. The pre-coat solution 20 does not have to be dried before the mask 27 is applied. However, some pre-coat solutions 20 may perform better if time is allowed for the pre-coat solution 20 to dry and/or cure before the mask 27 is applied. In some applications, it may be desirable to use a pre-coat solution 20 and/or a printer mask 27 that requires a selected amount of time to dry and/or cure.

Step 57 includes applying a mask 27 to the substrate 17, such as printing an ink on a glass sheet according to a selected pattern with the digital printer. Preferably, the pattern is printed directly onto the substrate 17. In an alternative embodiment, the step of printing the mask 27 on the substrate 17 may be carried out by using a screen printer and a screen printing process. Depending upon the type of screen printing process used and the type of ink used, the step of applying the pre-coat solution 20 may or may not be necessary. The screen printing embodiment is particularly well suited for applications in which a large number of glass panels having the same size and same mask pattern are to be prepared. In a preferred embodiment, the mask is applied as a negative, meaning the desired etched pattern is created by the sand blasting and not the masked portions of the substrate 17. In an alternative embodiment, the mask 27 is applied to obtain the desired pattern, and the sand blasting creates the surrounding features.

Step 59 includes etching the substrate 17, such as sandblasting the masked glass. The sandblasting step is performed by generally conventional techniques and materials for sandblasting and etching glass, such as with sand. However, it will be appreciated that alternative sandblasting techniques and/or materials may be used, such as wet or wheel blasting. Embodiments using other techniques and/or materials are specifically tailored for any specialized inks and/or coatings used to form the mask 27.

Step 61 includes cleaning the substrate 17, such as removing and/or stripping away the mask 27 and any pretreatment material from the glass to reveal the etched glass 39. At step 61, the cleaning step preferably comprises a stripping step to strip ink from the substrate 17. The step of stripping away the ink from the substrate may be performed manually, partially manually, automated, or it may be performed in a fully-automated process. In the manual process, the ink is peeled away from the substrate in sheets, as the pre-coat solution prevents the ink from adhering directly to the glass.

Step 61 further includes removing any residual pre-coat solution and/or from the etched glass to further clean it. As with other steps, the cleaning process may be performed manually, or may be automated. Although conventional glass cleaners may be used to clean the etched glass, it will be appreciated that the cleaning solutions and/or solvents may be custom tailored based upon the types of pre-coats and/or inks used.

After the substrate is cleaned, it is removed from a mover, a conveyor belt, or generally from the etching assembly line or etching machine. Thereafter, the etched substrate 39 is loaded onto a transporter 41, such as a truck, and shipped or transported to a desired location.

Any or all of step 53 through step 61 may include sub-steps within the step. For example, step 61 may include a first stripping sub-step, to strip the mask from the glass, and a separate cleaning sub-step to remove any residual mask material and pre-coat solution from the glass.

Although the present application has been described in terms of using a digital printer and performing several discrete steps, it will be appreciated that the process of the present application may be performed on a single production machine having the capabilities to perform all of the necessary steps continuously. In such a machine, raw glass may fed into one end of the machine and customized etched glass may be fed out the other end of the machine.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description.

1. A method for etching a substrate, comprising:
loading the substrate onto a mask applicator to receive a mask;
applying a solution to the substrate to prevent the mask from permanently adhering to the substrate;
wherein the solution is a silicone polymer;
applying the mask to the substrate using the mask applicator;
etching the substrate with an etch applicator; and
cleaning the substrate to remove the mask from the substrate.

2. The method according to claim 1, wherein:
the mask applicator is a digital flatbed printer.

3. The method according to claim 2, wherein:
the substrate is loaded laterally onto a lateral mover of the digital flatbed printer.

4. The method according to claim 2, wherein:
the mask is printed directly onto the substrate.

5. The method according to claim 1, wherein:
the mask applicator is a screen printer.

6. The method according to claim 5, wherein:
the mask is printed onto a plurality of substrates.

7. The method according to claim 1, wherein:
the solution is a pre-coat solution;
the solution is applied using a spray applicator; and
the solution is applied to an entire surface of the substrate.

8. The method according to claim 1, further comprising:
stripping the mask from the substrate prior to cleaning residual materials from the substrate.

9. The method according to claim 1, wherein:
the etch applicator is a sandblaster.

10. The method according to claim 1, wherein:
the etching of the substrate comprises:
a dry etching process.

11. The method according to claim 1, further comprising:
loading the substrate vertically into the etch applicator.

12. The method according to claim 1, wherein:
at least one of the loading, applying, etching, and cleaning is performed automatically.

13. The method according to claim 1, wherein:
each of the loading, applying, etching, and cleaning are performed automatically within a single machine.

14. The method according to claim 1, further comprising:
remotely actuating at least one of the mask applicator and the etch applicator.

15. An etched substrate having an etched portion, the etched portion being formed on a substrate using a tailored etching process, comprising:
loading the substrate onto a mask applicator to receive a mask;
applying a solution to the substrate using a solution applicator to prevent the mask from permanently adhering to the substrate;
wherein the solution is a silicone polymer;
applying the mask to the substrate using the mask applicator;
etching the substrate with an etch applicator; and
cleaning the etched substrate to remove the mask from the etched substrate.

16. The etched substrate according to claim 15, wherein:
the mask applicator is a digital flatbed printer.

17. The etched substrate according to claim 16, wherein:
the mask is printed directly onto the substrate.

18. The etched substrate according to claim 16, wherein:
the substrate is a glass sheet.

19. The etched substrate according to claim 18, wherein:
the substrate is loaded laterally onto a lateral mover of the digital flatbed printer.

20. The etched substrate according to claim 19, wherein:
the lateral mover has an automatic feed mechanism to advance the glass sheet through the printer.

21. The etched substrate according to claim 15, wherein:
the mask applicator is a screen printer.

22. The etched substrate according to claim 21, wherein:
the mask is printed onto a plurality of substrates.

23. The etched substrate according to claim 15, wherein:
the solution is a pre-coat solution;
the solution applicator is a spray applicator; and
the solution is applied prior to applying the mask to the substrate.

24. The etched substrate according to claim 15, further comprising:
stripping the mask from the substrate prior to cleaning residual materials from the substrate.

25. The etched substrate according to claim 15, wherein:
the etch applicator is a sandblaster.

26. The etched substrate according to claim 25, wherein:
the etching the substrate comprises a dry etching process.

27. The etched substrate according to claim 15, wherein:
the mask is applied to the substrate as a negative, creating a desired pattern on the substrate.

28. The etched substrate according to claim 15, further comprising:
loading the substrate vertically into the etch applicator.

29. The etched substrate according to claim 15, wherein:
at least one of the loading, applying, etching, and cleaning is performed automatically.

30. The etched substrate according to claim 15, wherein:
each of the loading, applying, etching, and cleaning are performed automatically within a single machine.

31. The etched substrate according to claim 15, further comprising:
remotely actuating each of the mask applicator and the etch applicator.
